(19) United States
(12) Patent Application Publication
(10) Pub. No.: US 2007/0257135 A1
(43) Pub. Date: Nov. 8, 2007

(54) Spray Nozzle

(76) Inventor: David Robert Percival, Warrington (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/736,810

(22) Filed: Apr. 18, 2007

(30) Foreign Application Priority Data
Apr. 19, 2006 (GB) 0607667.3

(51) Int. Cl. B05B 7/04

(52) U.S. Cl. 239/433; 239/600; 239/589

(57) ABSTRACT

A spray nozzle comprises a nozzle body having a gas inlet connected to a gas supply line and a liquid inlet connected to a liquid supply line, and an orifice body controlling the rate at which liquid can flow, in use, from the liquid inlet to a mixing zone, wherein the orifice body is removable from the nozzle body without requiring disconnection of the nozzle body from the liquid supply line.

This invention relates to a spray nozzle. In particular, the invention relates to a spray nozzle suitable for use in the continuous or substantially continuous delivery of a fine mist of liquid droplets.

One application in which spray nozzles of this type are used is in the cooling of the foundry output in the manufacture and casting of steel or other metals. It is important, in such applications, for the mist to be delivered constantly and consistently. If the spray nozzle becomes blocked or partly blocked, cooling is impaired and this can result in a reduction in the quality of the cast material and can also permit so-called ‘break-outs’ of molten material in the regions where insufficient cooling is occurring.

With the conventional spray nozzles, clearing of a blockage involves removal and dismantling of the spray nozzle. Given the hostile environment in which the spray nozzles are used, this is a time-consuming exercise. Further, casting operations have to be halted whilst the spray nozzle is being cleared, thus clearing of blockages is also expensive.

A further disadvantage of typical nozzles is that they are only capable of delivering fluid at a specific flow rate. To vary the delivery rate requires replacement of the nozzles, and this is time-consuming for the same reasons as set out above.

According to the invention there is provided a spray nozzle comprising a nozzle body having a gas inlet connected to a gas supply line and a liquid inlet connected to a liquid supply line, and an orifice body controlling the rate at which liquid can flow, in use, from the liquid inlet to a mixing zone, wherein the orifice body is removable from the nozzle body without requiring disconnection of the nozzle body from the liquid supply line.

Such an arrangement is advantageous in that the orifice body can be removed for cleaning, servicing or replacement without requiring removal of the entire spray nozzle, thus simplifying these operations.

Conveniently, the orifice body is provided with a bore defining a flow restriction, an inlet port communicating with the bore, the bore being a through bore closable, at one end, by a removable access cap.

The provision of such a through bore and removable access cap permits clearing of at least some blockages with the orifice body in situ, thus allowing such blockages to be cleared in a simple and efficient manner, reducing the period of time during which the spray nozzle cannot be used.

The invention further relates to an orifice body suitable for use in such a spray nozzle, and to an orifice body including a through bore and access cap as described hereinbefore.

The invention will further be described, by way of example only, with reference to the accompanying drawings, in which:

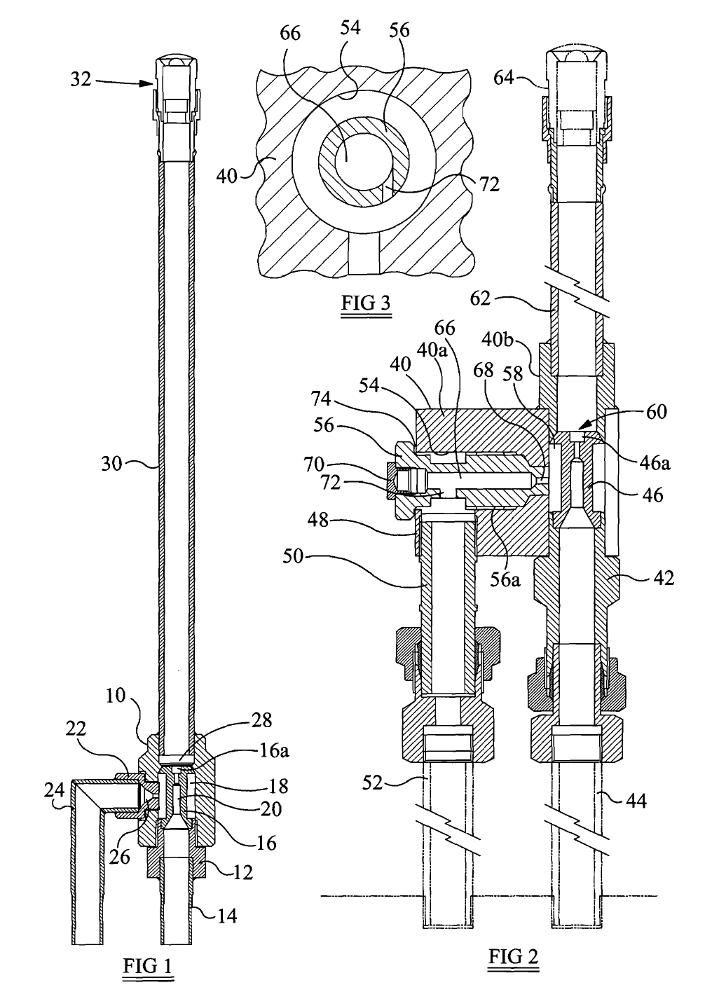

FIG. 1 is a sectional view illustrating a known spray nozzle; and

FIG. 2 is a view similar to FIG. 1 illustrating a spray nozzle in accordance with an embodiment of the invention; and

FIG. 3 is a diagram illustrating a modification.

Referring firstly to FIG. 1 there is illustrated a known spray nozzle comprising a nozzle body 10 to which is secured an air inlet connector 12 welded or otherwise secured to an air inlet pipe 14. The air inlet connector 12 is in screw-threaded engagement with the nozzle body 10 and locates an air orifice member 16 within a chamber 18 formed in the nozzle body 10. The air orifice member 16 includes a through bore 20 defining a region of reduced diameter forming an orifice or restriction to the rate at which air can flow through the orifice member 16. The spray nozzle further comprises a water inlet member 22 in screw-threaded engagement with the nozzle body 10, a water inlet pipe 24 being welded or otherwise secured to the water inlet member 22. The water inlet member 22 is shaped to define a through bore 26 defining an orifice or restriction to the rate at which water can enter the chamber 18 from the water supply line 24.

The air orifice member 16 forms, with the chamber 18, an annular region into which the water is delivered through the through bore 26, a pair of outlets (not shown) formed by a cross-slot 16a formed in the orifice member 16 delivering water from said annular chamber to the air flowing along the through bore 20 so as to form a mist of water droplets in a mixing zone 28. The droplets pass through a lance 30 and are delivered through a spray head 32 in the desired location.

As described hereinbefore, it is desirable when the spray nozzle is used in the cooling of cast metal, for water droplets to be delivered substantially continuously from the spray nozzle. In the event that the through bore 26 becomes blocked or partially blocked, for example due to the presence of particles or contaminants in the water flowing through the water supply line 24, then cooling of the cast products can be impaired and this is undesirable. In the event of a blockage or partial blockage of the through bore 26, in order to permit cleaning, the water inlet 24 must be disconnected from the nozzle body 10 so as to be able to gain access to the through bore 26. In order to do this, typically the nozzle body 10 will also need to be disconnected from the air inlet 12. It will be appreciated, therefore, that clearing of blockages is a time-consuming operation and, bearing in mind that casting operations must be halted whilst the cleaning is undertaken, it is also a costly operation.

A further disadvantage of the arrangement of FIG. 1 is that adjustment of the size of the orifice or restriction to the rate at which water can be delivered entails replacement of the water inlet 22 and as this component is welded to the water inlet line 24, this is not a simple operation.

FIG. 2 illustrates a spray nozzle in accordance with an embodiment of the invention. The arrangement of FIG. 2 sets out to overcome the disadvantages set out above in relation to the known arrangement described hereinbefore. The arrangement of FIG. 2 comprises a nozzle body 40 to which an air inlet 42 is connected by a screw-threaded connection. The air inlet 42, in turn, is connected to an air supply line 44. The air inlet 42 locates, within the nozzle body 40, an air orifice member 46 of form substantially the same as the air orifice member 16 of the arrangement shown in FIG. 1. For convenience, the nozzle body 40 is of two-part form, comprising parts 40a and 40b, but this need not always be the case. The part 40b further serves as a connector to which a lance 62 (see below) is secured.

The nozzle body 40 further includes a water inlet port 48 to which a water inlet member 50 is secured by a screw-threaded connection, the water inlet member 50 being secured to a water supply line 52.

The nozzle body 40 is formed with a passage 54 in which is located a water orifice member 56 to convey water from the water inlet port 48 to an annular chamber 58 defined around the air orifice member 46. As with the arrangement described hereinbefore with reference to FIG. 1, water from the chamber 58 is able to flow through a cross-slot 46a to a mixing zone 60 where the air flow forms the water into a mist of water droplets, the mist of water droplets being conveyed along the lance 62 and through a spray head 64 to the desired location.

The water orifice body 56 comprises a substantially cylindrical body, part 56a of which is formed with screw-thread formations to allow the water orifice body 56 to be secured within the passage 54 formed in the nozzle body 40. The water orifice body 56 is formed with a through bore 66 shaped to define a region 68 of reduced diameter forming an orifice or restriction to the rate at which water can flow through the orifice body 56. The through bore 66 is closed, at its end remote from the region 68 by an access cap 70 which is securable in position by a screw-threaded connection. The water orifice body 56 further includes a water inlet port 72 defined by a passage perpendicular to, and communicating with, the through bore 66.

In order to minimise or prevent leakage of water between the nozzle body 40 and the water orifice member 56, a deformable copper sealing washer 74 is conveniently trapped therebetween.

In use, with the spray nozzle connected to the air and water supply lines 44, 52 as illustrated, water is supplied to the inlet port 48 of the nozzle body 40 to the water orifice member 56 from where it flows along the through bore 66 and through the region 68 to the annular chamber 58. From the annular chamber 58, water is able to flow through the cross-slot 46a to the mixing zone 60 where the action of the air supplied through the air orifice member 46 causes the water to atomize and form a mist of water droplets. The mist of water droplets is carried through the lance 62 to be delivered by the head 64 in the desired location and in the desired pattern.

In the event that a blockage forms in the through bore 66 formed in the water orifice member 56, rather than requiring the nozzle to be totally removed and dismantled, the access cap 70 can be removed from the water orifice body 56, and compressed air supplied to the through bore 66. The action of applying the compressed air will typically clear the blockage thus, once the access cap 70 has been re-secured in position, normal operation of the spray nozzle can continue. In the event that the application of compressed air to the through bore 66 in this manner is unsuccessful in clearing the blockage, then the water orifice body 56 can be removed from the remainder of the spray nozzle to permit cleaning, replacement or servicing thereof, again without requiring removal of the complete spray nozzle. After cleaning of the water orifice body 56, it can be returned to its operative position as shown in FIG. 2, typically with the sealing washer 74 having been replaced in order to maintain the integrity of the seal between the water orifice body 56 and nozzle body 40. It will be appreciated that both of these operations can be conducted without disconnecting the nozzle from the water and air supply lines, and so can be conducted relatively quickly and with minimum disruption to the production process.

A further advantage of the arrangement illustrated in FIG. 2 as compared to conventional arrangements is that, in the event that it is desired to vary the rate at which the mist of water droplets is delivered, this can be achieved by replacing the water orifice body 56 with one having a region 68 of a different diameter. Again, clearly this can be achieved without requiring replacement of the entire spray nozzle.

The arrangement described hereinbefore may be used in other ways. For example, rather than providing an access cap 70 to close the end of the through bore 66, a further fluid inlet line could be connected thereto. One possibility is to connect an additional air line thereto. This has the advantage that, by appropriate control over the pressure of the additional air line, the water supply rate can be changed without having to adjust its supply pressure. Further, the water is, at least partially, atomized prior to reaching the mixing zone 60, thereby permitting the nozzle to be used in the formation of a spray of reduced droplet size compared to typical arrangements.

The nozzle may be modified to orientate the water inlet port 72 such that it is tangential to the through bore 66, thereby imparting a swirling motion to the water, as shown in FIG. 3. The formation of a swirling motion in the water results in the water passing through the region 68 in the form of a hollow conical spray. Consequently, the size of the region 68 can be increased, leading to a reduction in the risk of it becoming blocked, without resulting in an increase in the rate at which water passes through the region 68.

It will be appreciated that a range of modifications and alterations to the arrangement described hereinbefore may be made without departing from the scope of the invention. Further, although the description hereinbefore relates to the formation of a spray of water droplets, the spray nozzle may be used with other fluids.

1. A spray nozzle comprising a nozzle body having a gas inlet connected, in use, to a gas supply line and a liquid inlet connected, in use, to a liquid supply line, and an orifice body controlling the rate at which liquid can flow, in use, from the liquid inlet to a mixing zone, wherein the orifice body is removable from the nozzle body without requiring disconnection of the nozzle body from the liquid supply line.

2. A nozzle according to claim 1, wherein the orifice body is provided with a bore defining a flow restriction, an inlet port communicating with the bore.

3. A nozzle according to claim 2, wherein the bore is a through bore closable, at one end, by a removable access cap.

4. A nozzle according to claim 2, wherein the inlet port opens generally tangentially to the bore.

5. A nozzle according to claim 1, wherein the orifice body is in screw threaded engagement with the nozzle body.

6. An orifice body adapted for use in a spray nozzle according to claim 1.
